(19) United States
(12) Patent Application Publication
(10) Pub. No.: US 2025/0243018 A1
(43) Pub. Date: Jul. 31, 2025

(54) CUP LOADER AND DENESTER ASSEMBLY

(71) Applicant: Winpak Lane, Inc., Rialto, CA (US)

(72) Inventors: Steven Davis, Rialto, CA (US); Dirk Balter, Corona, CA (US)

(21) Appl. No.: 18/426,143

(22) Filed: Jan. 29, 2024

(51) Int. Cl. B65G 59/10

(52) U.S. Cl. CPC B65G 59/102; B65G 2201/0235

(57) ABSTRACT

A cup handling apparatus including a frame, a cup magazine assembly and a cup loader assembly. The cup magazine assembly includes a magazine frame and a cup dropper assembly. The magazine is configured to retain cups with the cup dropper assembly configured to controllably release cups from the magazine frame. The cup loader assembly includes a cup holding box, a cup release assembly and a box movement subassembly. The cup loader assembly is configured to fill the magazine frame with cups, and can be moved from a cup loading configuration to a magazine loading configuration.

### CROSS-REFERENCE TO RELATED APPLICATION

N/A

### BACKGROUND OF THE DISCLOSURE

### 1. Field of the Disclosure

The disclosure relates in general to package handling equipment, and more particularly, to a cup handling apparatus, which may be incorporated into a filler of such cups. Of course, the disclosure is not limited to any particular types of cups, fillers or the like. However, the cup handling apparatus is particularly useful for the handling of cups which can be sequentially delivered to a filler to be filled with material and subsequently capped (often with a foil or similar seal).

### 2. Background Art

The filling of cups is known in the art. Such cups can be filled with any number of different, typically flowable materials, including, but not limited to, dressings, condiments, dairy products, syrups, flavorings, among others. Typically, cups are dispensed into a filler, then filled, and sealed with a removable cover (through heat, RF, ultrasonic, or other methods). Such cups can vary greatly in size and shape.

In some instances, it is difficult to keep an adequate supply of cups for a filler or for subsequent processing. For example, for shallower cups, the cups can become de-nested wherein the cups can then tumble and become lodged during cup handling, or may be difficult to dispense. It will be understood that any stoppage of the downstream equipment can cause disruption that far exceeds the amount of time of the stoppage.

### SUMMARY OF THE DISCLOSURE

The disclosure is directed in an aspect to a cup handling apparatus. The cup handling apparatus includes a frame, a cup magazine assembly and a cup loader assembly. The cup magazine assembly is attached to the frame. The cup magazine assembly includes a magazine frame and a cup dropper assembly. The magazine frame has a lower plate and an upper plate spaced apart from the lower plate. The upper plate has a plurality of cup bores, and the lower plate has a plurality of cup bores, with guides extending between the upper and lower plate about the cup bores of the upper and lower plates. The cup dropper assembly has a plurality of cup dropper disks that are rotatably extendable into the footprint of the cup bores of the lower plate. Each cup dropper disk having an upper portion having at least one upper lobe and a lower portion having at least one lower lobe, defining a channel therein.

The cup loader assembly is attached to the frame and includes a cup holding box structure, a cup release assembly and a box movement subassembly. The cup holding box is structurally configured to receive cups, and includes a base having a plurality of bores that correspond to the cup bores of the upper plate. The cup release assembly is slidably movable relative to the base of the cup holding box, to selectively correspond to the plurality of bores of the base. The box movement subassembly guides the cup holding box from a cup loading configuration wherein the cup holding box is oblique to the cup magazine frame to a magazine loading configuration wherein the cup holding box overlies the magazine frame with the plurality of bores of the base aligned with the cup bores of the upper plate.

In some configurations, the magazine frame further includes at least one holdback assembly positioned between the upper plate and the lower plate. The at least one holdback assembly includes a cup retainer subassembly selectively precluding and allowing the passage of cups therebeyond.

In some configurations, the at least one holdback assembly further includes a holdback plate that is positioned so as to be substantially parallel to at least one of the lower plate and the upper plate. An inner retaining bracket is positioned on an inner side of at least one of the cup bores and an outer retaining bracket positioned on an outer side of the at least one of the cup bores. The inner retaining bracket and the outer retaining bracket are extendable into the at least one of the cup bores to selectively preclude and allow the passage of a cup therebeyond.

In some configurations, each of the outer retaining bracket and the inner retaining bracket further include a cup capture flange and an outer surface which cooperate to retain a cup and preclude the passage of the cup therebeyond.

In some configurations, the upper portion of the cup dropper disk includes four upper lobes and four lower lobes, with at least one of the cup dropper disks having at least one of the four upper lobes and at least one of the four lower lobes extendable into two adjacent cup bores of the lower plate of the magazine frame simultaneously.

In some configurations, the cup dropper disk further includes a drive pivot that is spaced apart from the pivot axis. The cup dropper assembly further includes a push rod being slidably movable relative to the pivot axis while being coupled to the drive pivot, wherein slidable movement of the push rod engages the drive pivot, rotating the cup dropper disk.

In some configurations, the push rod engages a drive pivot of a plurality of cup dropper disks, whereupon slidable movement of the push rod rotates a plurality of the cup dropper disks.

In some configurations, the push rod is attached to an actuator that is coupled to the magazine frame, the actuator configured to slidably move the push rod.

In some configurations, the cup handling apparatus of further includes a guide assembly. The guide assembly includes a first side mating track, a second side mating track and mating pins. The first side mating track extends along a portion of a first side the frame. The second side mating track extends along a portion of a second side of the frame. A pair of first side mating pins are spaced apart and extend from a first side of the base and extendable into the first side mating track, the first side mating pins are movable along the first side mating track. A pair of second side mating pins are spaced apart and extend from a second side of the base and extendable into the second side mating track, the second side mating pins are movable along the second side mating track.

In some configurations, the first side of the frame includes a front leg and an upper support with a curved portion therebetween. The second side of the frame includes a front leg and an upper support with a curved portion therebetween. The first side mating track extends along a portion of the front leg, upper support and curved portion of the first side of the frame. The second side mating track extends along a portion of the front leg, upper support and curved portion of the second side of the frame.

In some configurations, the front leg is oblique to the upper support of the first side of the frame, while being substantially parallel to the upper plate of the magazine frame. The front leg is oblique to the upper support of the second side of the frame, while being substantially parallel to the upper plate of the magazine frame.

In some configurations, the box movement assembly further includes a lower slide including a first guide pin slidably positionable within the first side mating track and a second guide pin slidably positionable within the second side mating track. A motor is coupled to the lower slide and includes an axle terminating in a gear. At least one side rack is associated with at least one of the front leg of the first side of the frame and the front leg of the second side of the frame. The gear meshes with the at least one side rack, whereupon actuation of the motor rotates the gear and translates the lower slide relative to the at least one side rack. At least one linkage couples the lower slide to the cup holding box, wherein the cup holding box is structurally configured to rotate relative to the lower slide.

In some configurations, the axle includes a second gear, and the at least one rack comprises a first rack associated with the front leg of the first side of the frame and a second rack associated with the front leg of the second side of the frame. The gear meshes with the first rack and the second gear meshing with the second rack.

In some configurations, the travel of a cup through the cup magazine and through the cup loader assembly is linear.

In another aspect of the disclosure, the disclosure is directed to a cup loader assembly attachable to a frame. The cup loader assembly includes a cup holding box, a cup release assembly and a box movement assembly.

In another aspect of the disclosure, the disclosure is directed to a cup magazine assembly attachable to the frame. The cup magazine assembly includes a magazine frame and a cup dropper assembly.

### BRIEF DESCRIPTION OF THE DRAWINGS

The disclosure will now be described with reference to the drawings wherein:

FIG. 1 of the drawings is a perspective view of the cup handling apparatus of the present disclosure;

FIG. 2 of the drawings is a first side elevational view of the cup handling apparatus of the present disclosure;

FIG. 3 of the drawings is a second side elevational view of the cup handling apparatus of the present disclosure;

FIG. 4 of the drawings is a top plan view of the cup handling apparatus of the present disclosure;

FIG. 5 of the drawings is a perspective view of the cup magazine assembly of the cup handling apparatus of the present disclosure;

FIG. 6 of the drawings is a front elevational view of the cup magazine assembly of the cup handling apparatus of the present disclosure;

FIG. 7 of the drawings is a perspective view of the first holdback assembly of the present disclosure, with the understanding that the second holdback assembly has a substantially identical configuration;

FIG. 8 of the drawings is a perspective view of the cup dropper assembly mounted on a portion of the lower plate of the present disclosure;

FIG. 9 of the drawings is a partial perspective view of the cup dropper assembly, showing, in particular, a cup dropper disk in operable engagement with the pivot shaft and the push rod;

FIG. 10 of the drawings is a top plan view of a portion of the cup dropper assembly, showing, in particular, a plurality of cup dropper disks interfacing with multiple cup bores of the lower plate of the present disclosure;

FIG. 11 of the drawings is a perspective view of an cup dropper disk with pivot shaft of the present disclosure;

FIG. 12 of the drawings is a back perspective view of a portion of the frame and the cup loader assembly of the present disclosure in operable engagement with the frame;

FIG. 13 of the disclosure is a perspective view of a portion of the cup loader assembly of the present disclosure;

FIG. 14 of the disclosure is a perspective view of a portion of the cup loader assembly of the present disclosure;

FIG. 15 of the disclosure is perspective view of a portion of the cup loader assembly;

FIG. 16 of the disclosure is a perspective view of a portion of the cup loader assembly; and

FIG. 17 of the disclosure is a perspective view of a cup that can be utilized with the cap handling apparatus of the present disclosure.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

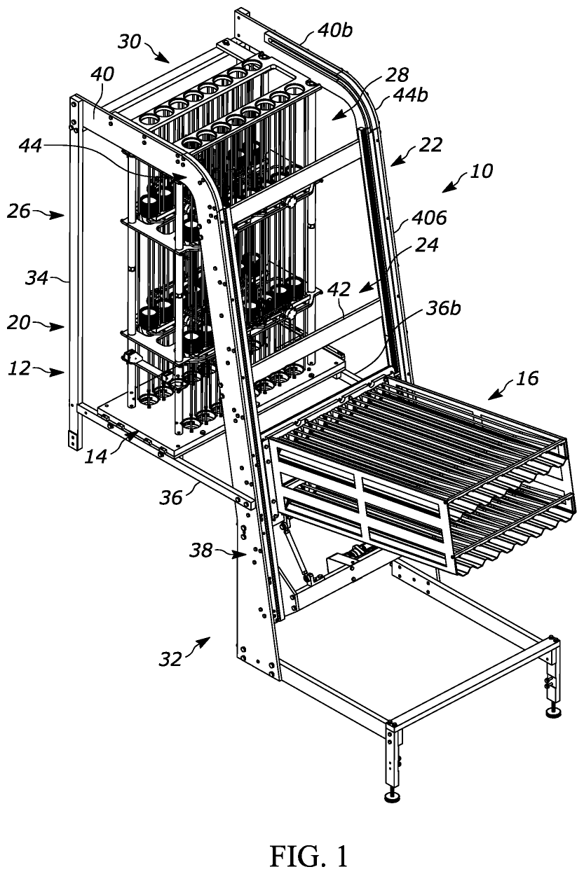

Referring now to the drawings and in particular to FIG. 1, the cup handling apparatus for a filler is shown generally at 10. The cup handling apparatus for a filler is configured for use in association with a filler of cups, such as cups that are used for dressings, condiments, dairy products, syrups, flavorings, among other flowable material and solids. One such filler is a filler marketed under the TITAN SERIES cup machine offered by Winpak Ltd. of Winnipeg, Manitoba. Of course, the apparatus is not limited to use in association with such a filler, a filler by the maker of said filler, or any particular filler; rather, the apparatus has wide range of fillers to which such an apparatus can be adapted and utilized.

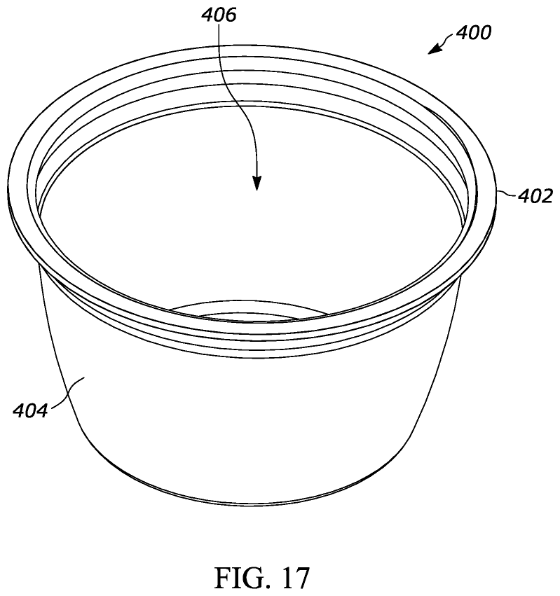

An illustrative example of a cup 400 is shown in FIG. 17 as including rim 402 and body 404 forming cavity 406. Typically, such cups range in size from approximately 11 ml to more than 180 ml. Of course, there may be variations including cups that are both larger and smaller in capacity. While different shapes are contemplated, the openings are generally sized to be circular with diameters of 50 mm to 75 mm. Again, these are solely exemplary and are not deemed limiting. In particular, both larger and smaller openings are contemplated, and shapes other than circular openings are contemplated for handling by such an apparatus.

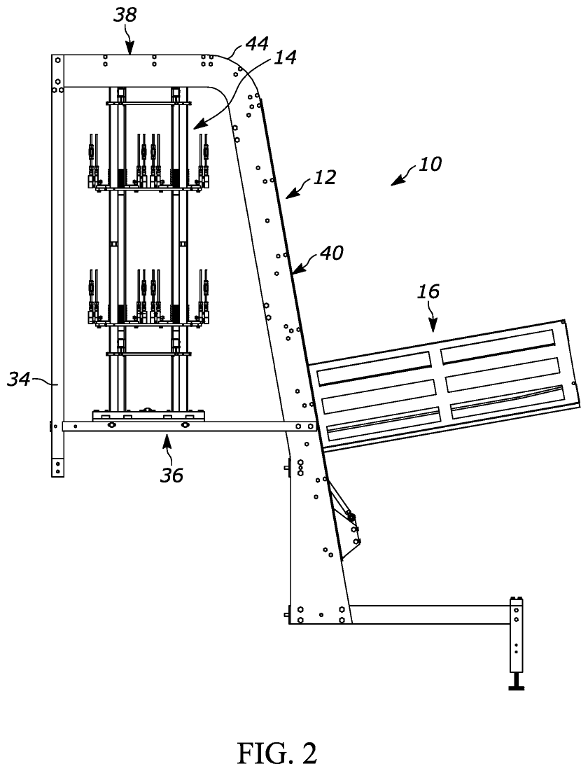

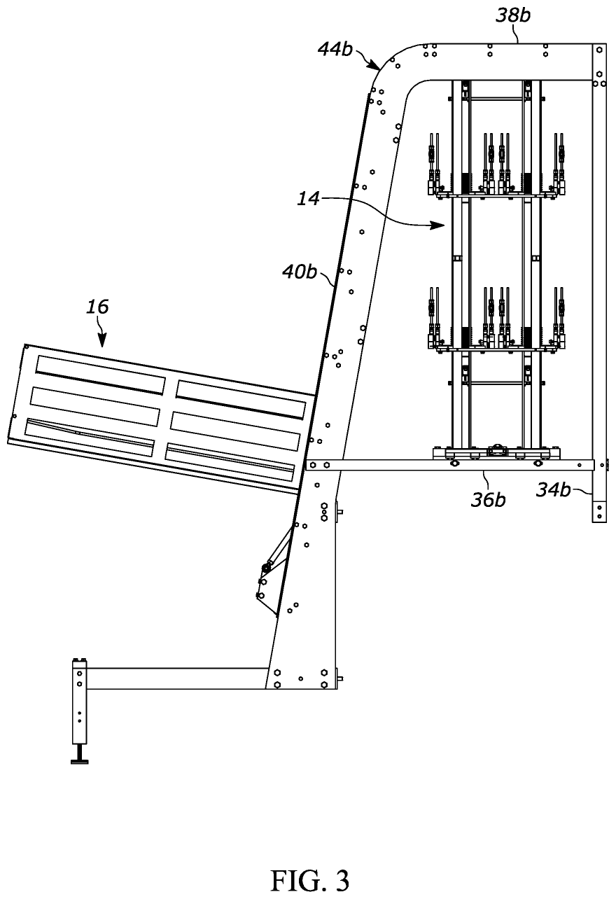

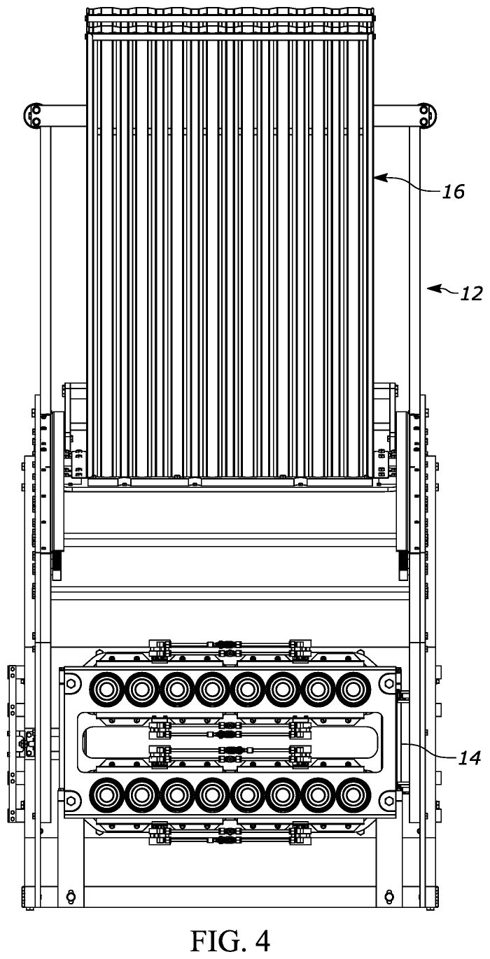

Referring again to the Figures, and in particular, FIGS. 1 through 4, the apparatus 10 is shown as comprising frame 12, cup magazine assembly 14 and cup loader assembly 16. The frame 12, which is attachable to a filler is defined by first side 20, second side 22, front 24, back 26. The frame is attachable, preferably, to a filler, such that the cups are removed from the bottom end of the filler (where the outlet of the cups from the cup magazine assembly). The frame, in the configuration shown, comprises a plurality of support members that form a cavity 28. In the particular configuration shown, the first side includes a first rear leg 34, a first lower beam 36, a first upper support 38 and a first front leg 40. In the configuration shown, the first front leg and the first upper support are formed so as to flow from one structure to the other through curved portion 44. The second side is generally a mirror image of the first side, and any reference numbers to the second side are the same reference numbers augmented with the letter “b”. A plurality of cross supports, such as cross support 42 extend between the first side and the second side, preferably between the front legs 40, 40b and the rear legs 34, 34b.

In the configuration shown, the frame comprises a plurality of metal beams, while other materials are contemplated for use. Additionally, in the configuration shown, each of the sides comprises a mirror image, while it is contemplated that the sides may be different from each other, and the entire structure may be differently formed. The frame is configured to retain the cup magazine assembly 14 so that sequentially cups can be provided to the filler. The frame is also configured to retain the cup loader assembly which provides for the cup loader assembly repositioning from an orientation wherein the cup loader assembly can be filled with cups, to an orientation wherein the cups are positioned so as to be loaded into the cup magazine assembly for introduction into the loader.

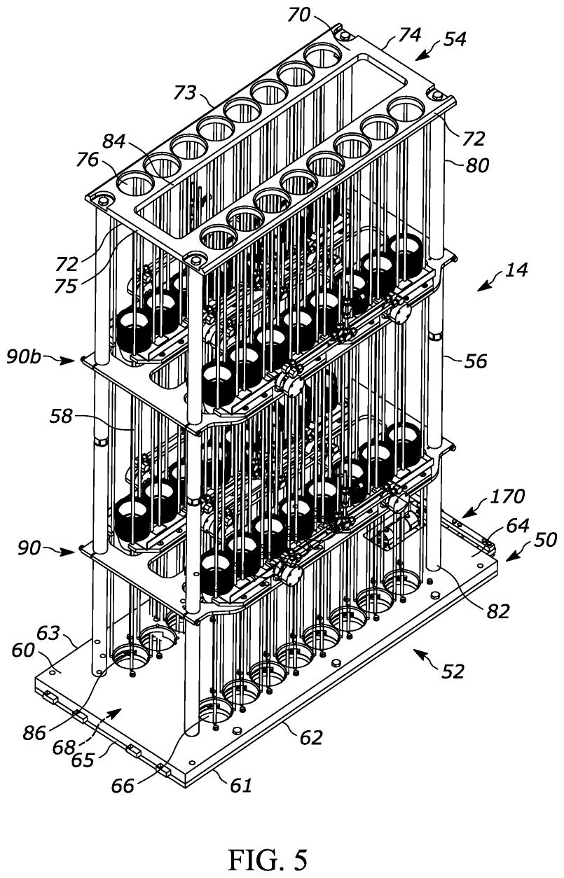

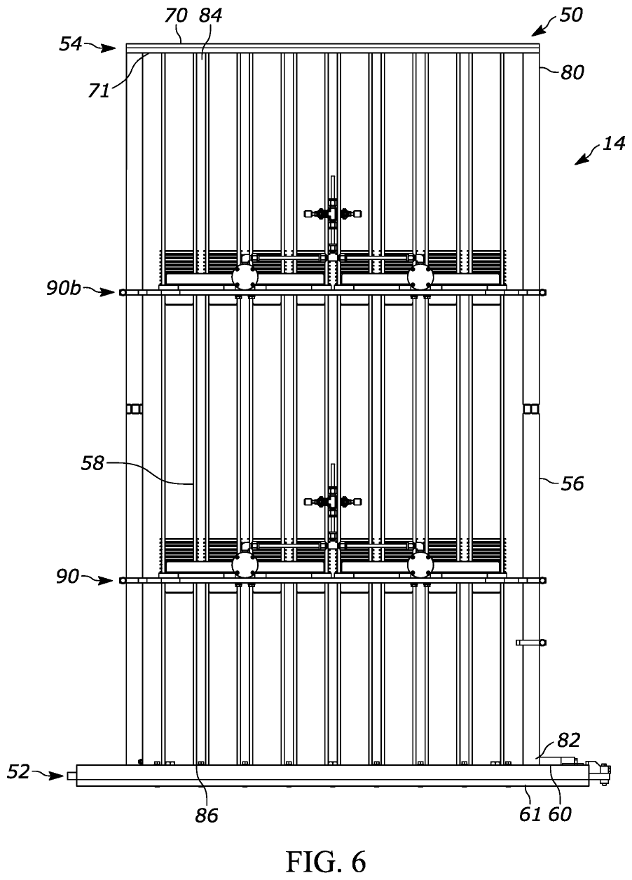

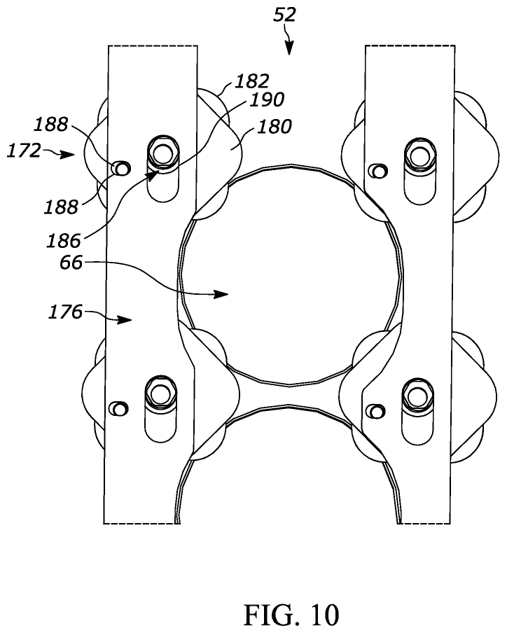

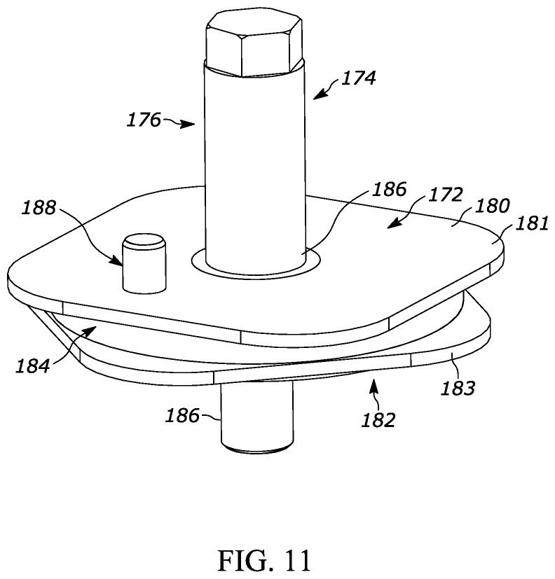

With further reference to FIGS. 5 through 11, the cup magazine assembly 14 is shown as comprising magazine frame 50, at least one holdback assembly, such as first holdback assembly 90, and cup dropper assembly 170. In the configuration shown, there is a further, second holdback assembly 90b spaced apart from the first holdback assembly. As will be understood, and explained below, the cup magazine assembly 14 is configured to provide cups sequentially to the filler, while maintaining a supply of cups within the magazine to insure that the filler can be properly supplied with cups throughout its operation.

The magazine frame 50 includes lower plate 52, upper plate 54, frame shaft 56 and guide shaft 58. The lower plate is defined by a top 60, bottom 61, front 62, back 63, first side 64 and second side 65. The lower plate extends between the first lower beam 36 and the second lower beam 36b with the first side 64 being coupled to the first lower beam 36a and the second side 65 being coupled to the second lower beam 36b. In the configuration shown, the lower plate is substantially rectangular in configuration with the sides being parallel to each other and perpendicular to each of the front and back.

A plurality of cup bores, such as cup bore 66 extend through the upper plate generally perpendicular to the top 60 and bottom 62. In the configuration shown, a total of sixteen spaced apart cups that are formed into two rows of eight are defined in the upper plate. As will be understood, the openings are sized so as to correspond to the cups that will be utilized with the magazine, so as to allow the cup to extend therethrough. The lower plate may be defined by multiple components, with a void created therebetween defining an internal channel 68. The internal channel 68 extends about the openings. For example, in the configuration shown, the internal channel surrounds each row of eight openings. As will be explained, this configuration allows for the retention of components associated with the cup dropper assembly 170.

The upper plate 54 is spaced apart from the lower plate 52 in an overlying manner, wherein, preferably, the lower plate and the upper plate are generally parallel to each other. The upper plate 54 is defined by top 70, bottom 71, front 72, back 73, first side 74 and second side 75. The upper plate includes a plurality of cup bores 76 which align with the cup bores 66 of the lower plate. The upper and lower plates define the entry and exit for the cups that will be loaded into the magazine, to pass therethrough and into the filler.

The upper plate 54 and the lower plate 52 are maintained in a spaced apart orientation in the configuration shown by frame shafts, such as frame shaft 86 that is coupled to the upper plate at top end 80 thereof, and coupled to the lower plate at the bottom end 82 thereof. In the configuration shown, a total of four frame shafts extend between the upper plate and the lower plate, one positioned in each corner of the rectangularly shaped upper and lower plates. Of course, in other configurations different structures can be used to maintain the upper and lower plates in the desired relative orientation (i.e., walls, beams, among other structures).

A plurality of guide shafts, such as guide shaft 58 extend between the lower plate 52 and the upper plate 54. Each guide shaft, such as guide shaft 58, includes a top end 84 and a bottom end 86. In the configuration shown, a total of four guide shafts extend are spaced about each cup bore of the lower plate and the corresponding one of the cup bores of the upper plate. The guide shafts provide guidance to cups that are passing from one end to the other within the magazine frame and also provide support for the cups that are stacked and/or otherwise maintained within the magazine frame. In other configurations, the rods may comprise structures that have configurations that are other than circular in cross-sectional configuration. In other configurations, a greater or lesser number of such rods may be utilized, and in some instances, structures that follow the contours of the cap (or the opening) are contemplated. As there are sixteen bores, there are a total of sixty-four guide shafts extending between the lower plate 52 and the upper plate 54. It will be understood that in some configurations fewer bores may be made, wherein the bores are configured for multiple cups. As such, there may be some guides that are used for multiple streams of cups, as there may be openings that are utilized for multiple streams of cups.

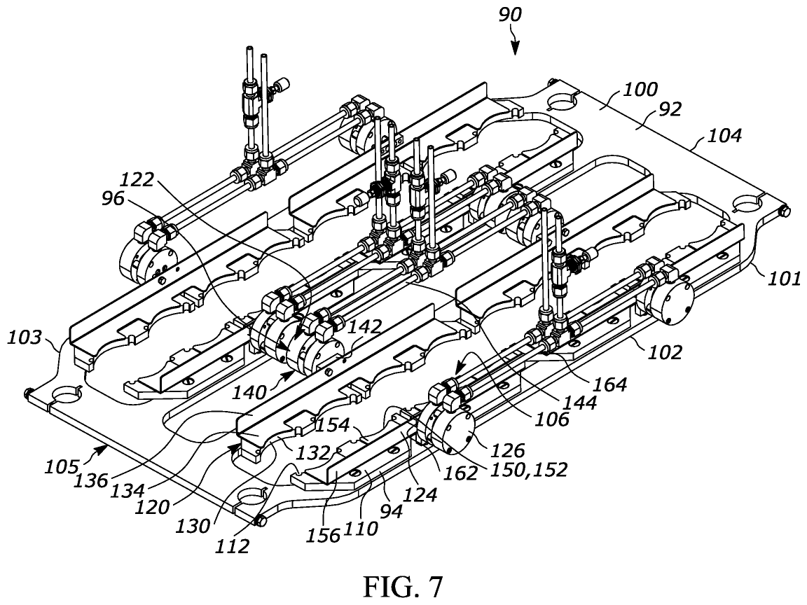

With particular reference to FIG. 7, the first holdback assembly 90 is shown as comprising holdback plate 92, rod supports 94 and cup retainer sub-assembly 96. The first holdback assembly provides intermediate locations for retaining cups within the magazine, while also providing for the support of guide rods that extend between the lower plate and the upper plate. The holdback plate 92 is defined by a top 100, bottom 101, front 102, back 103, first side 104 and second side 105. In the configuration shown, the holdback plate 92 generally corresponds to the upper plate and the lower plate, having a top surface parallel to each and being spaced between the two. The holdback plate 92 can be coupled to the frame shafts so as to be fixed in position relative thereto, and, as a result, fixed relative to the lower plate 52 and the upper plate 54.

The holdback plate includes a plurality of bores, with a bore 106a corresponding to one of the rows of the cup bores 66, 76 of the lower plate 52 and the upper plate 54, respectively, and a bore 106b corresponding to the other of the rows of the cup bores of the lower and upper plates. Additionally, the guide shafts 58 extend through these bores of the holdback plate. In some configurations, multiple bores may be formed, such as a bore for each opening of the upper and lower plates, or different combinations thereof.

A plurality of rod supports, such as rod support 94, are coupled to the holdback plate, each such rod support includes a mount region 110, which facilitates fastening to the holdback plate, and rod interface regions 112 (in the configuration shown, slots). In the configuration shown, rod support 94 is coupled to the top of the holdback plate and extends into the bore so as to capture four adjacent guide rods within the rod interface regions 112. This provides further support to the rods that extend between the lower plate and the upper plate, so as to maintain a desired orientation relative to the cups that are passing therethrough. Similarly, additional rod supports are disposed on the holdback plate, with each supporting four guide rods. Of course, other configurations are contemplated, such as incorporation of guide supporting in the holdback plate, having a rod support interfacing with a greater amount or a lesser amount of guide rods, sufficient to support the guide in a desired orientation.

The cup retainer subassembly 96 is shown as comprising sets of inner retaining brackets 120, inner actuators 122, outer retaining brackets 124 and outer actuators 126. The inner retaining bracket 120 includes a cup capture flange 130 and a mounting flange 136. The cup capture flange 130 includes an outer edge and an upper surface 134. The mounting flange is generally oriented perpendicular to the cup capture flange. The outer edge of the capture flange is configured to match the configuration of four side by side cups that are positioned in four side by side stacks as they proceed through the magazine, wherein the outer edge is positioned inboard of the cups.

The inner actuator 122 comprises, in the configuration shown, a pneumatic cylinder which includes body 140, actuating rod 142 and pneumatic tubing 144. The body 140 is coupled to the holdback plate, with the actuating rod 142 extending therefrom and coupled to the mounting flange 136 of the inner retaining bracket 120. Pneumatic tubing 144 is attached at one end to a source of air, and to the other end to the actuator. In the configuration shown, the actuator has a pair of pneumatic tubes to control the movement in each direction of the actuator pneumatically.

The outer retaining bracket 124 includes cup capture flange 150 and mounting flange 156. The cup capture flange 150 includes outer edge 152 and upper surface 154. The mounting flange is generally oriented perpendicular to the cup capture flange. The outer edge of the capture flange is configured to match the configuration of the four side by side cups that are positioned in four side by side stacks as they proceed through the magazine, wherein the outer edge is positioned outboard of the cups.

The outer actuator 126 likewise comprises a pneumatic cylinder which includes body 160, actuating rod 162 and pneumatic tubing 164. The body 160 is coupled to the holdback plate, with the actuating rod 162 extending therefrom and coupled to the mounting flange 156 of the outer retaining bracket 124. Pneumatic tubing 164 is attached at one end to a source of air, and to the other end to the actuator.

The inner retaining bracket 120 is positioned on the inboard side opposite of the outer retaining bracket 124, such that the respective actuators 122, 126 direct the retaining brackets toward and away from each other to selectively engage caps positioned therebetween. It will be understood that each cup retainer subassembly is configured to engage with four side by side streams of cups. Thus, for holdback assembly 90, a total of four cup retainer subassemblies are utilized to retain the sixteen streams of cups. In other configurations, there may be a greater or lesser number of cup retainer subassemblies. Additionally, other configurations are contemplated, such a, for example, the use of solenoids or other structures to achieve movement of the retaining brackets, including, but not limited to linkages that are driven by actuators, motors or the like.

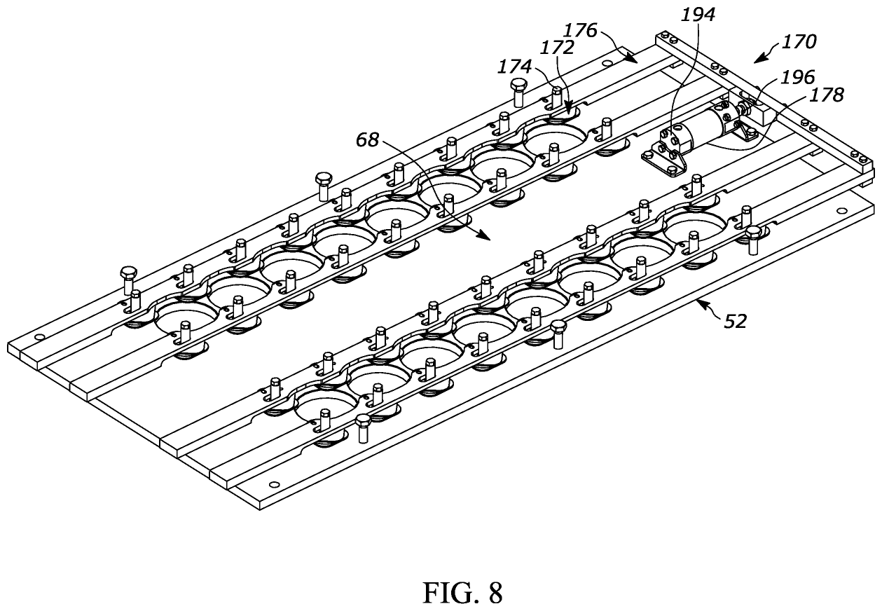

With further reference to FIG. 8 through 11, the cup dropper assembly 170 is shown as comprising a plurality of cup dropper disks, such as cup dropper disk 172, pivot shafts, such as pivot shaft 174, push rods, such as push rod 176 and actuator 178, associated with the lower plate 52. It will be understood that there are four cup dropper disks associated with each cup bore of the lower plate 52, along with a pivot shaft associated with each cup dropper disk. Additionally, adjacent bores utilize adjoining cup dropper disks, that is, a cap dropper disk has lobes that can enter multiple (i.e., two adjacent) bores. There are two push rods associated with each column of eight cup bores, with one on either side of the bore, and with each interfacing with eight cup dropper disks. The dropper actuator 178 is coupled to each of the push rods, so as to actuate the push rods in unison.

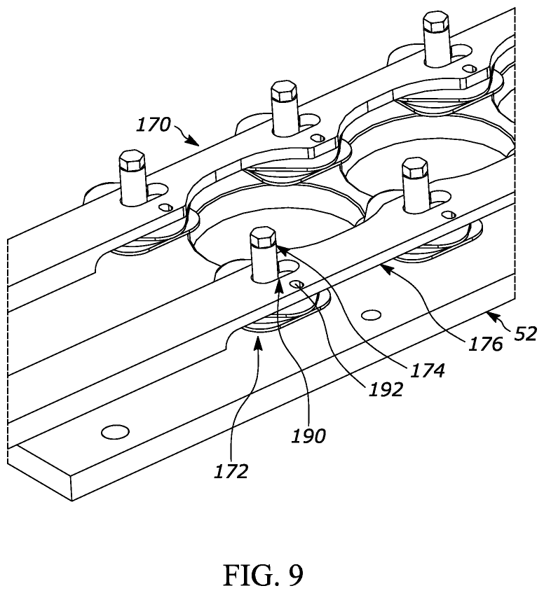

In light of the multiples of each of the structures, each component will be described, with interactions described thereinafter. Each of the thirty-six cup dropper disks generally have the same configuration, and as such, a single cup dropper disk will be described with the understanding that the remaining ones are substantially identical (or mirror images thereof). More specifically, and with reference to FIGS. 9 through 11, the cup dropper disk 172 comprises upper portion 180, lower portion 182, channel 184, pivot axis 186 and drive pivot 188. The upper portion 180 includes a plurality of upper lobes 181. Similarly, the lower portion 182 includes a plurality of lower lobes 183. The upper portion and the lower portion are spaced apart and offset relative to each other so as to both form the channel 184 therebetween and also so as to have an upper lobe positioned between each lower lobe and vice-versa. In the configuration shown, there are a total of four upper lobes 181 and four lower lobes 183, which are positioned between the four upper lobes 181. The pivot axis 186 (defining an opening) is positioned in the natural center of the cup dropper disk so that the lobes are generally uniform about the pivot axis 186 (i.e., defining a central axis). The drive pivot 188 (which comprises an opening into which a pin is driven) is offset from the pivot axis 186.

The pivot shaft 174 is configured to extend through the opening of the pivot axis 186 and into the lower plate 52. The cup dropper disk 172 can freely rotate about the pivot axis 186.

The push rod 176 has a pivot coupling 190 which comprises an elongated hole configured to receive the pivot shaft 174 wherein the push rod can be slid relative to the pivot shaft 174, with the pivot shaft slidably moving in the elongated hole. The push rod 176 further includes drive coupling 192 which comprises an opening which engages the pin of the drive pivot 188, whereupon slidable movement of the push rod slidably moves the push rod relative tot eh pivot shaft, while causing rotation of the cup dropper disk through the engagement with the drive pivot.

It will be understood that each of the push rods have corresponding pivot couplings and drive couplings so as to engage each of the cup dropper disks in the same manner. In the configuration shown, a single connecting rod connects to each of the push rods so that they can be moved in unison.

The actuator 178 is coupled, in the configuration shown, to the push rods 176 (through the connecting rod). The actuator comprise a base that is coupled to the lower plate 52 and a rod 196 that is coupled to the connecting rod 196. As will be appreciated, pneumatic tubing can be supplied to the actuator (which comprises a pneumatic cylinder). In other configurations, the actuator may comprise a solenoid.

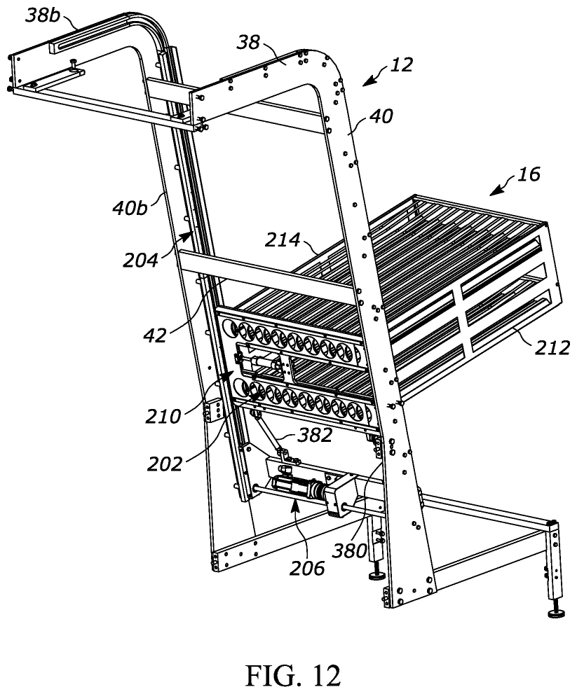

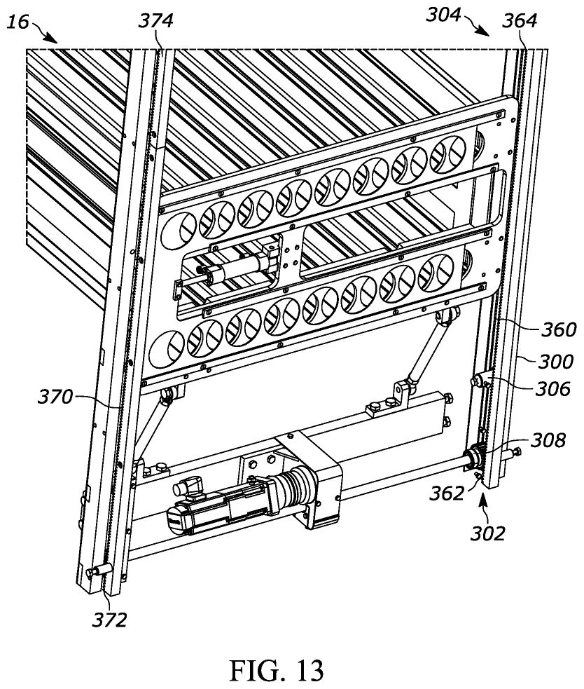

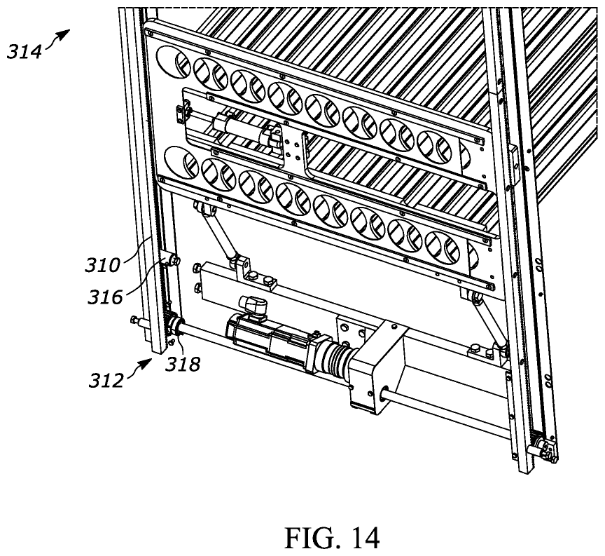

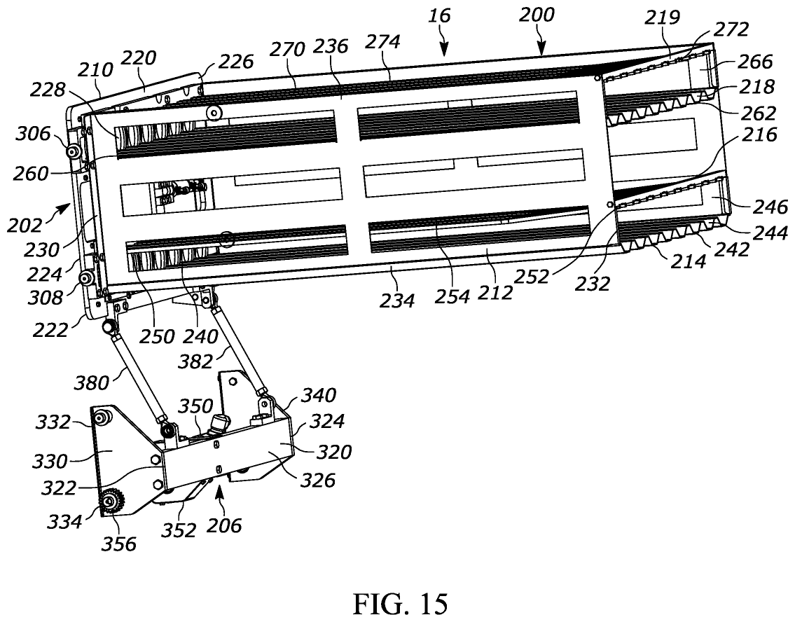

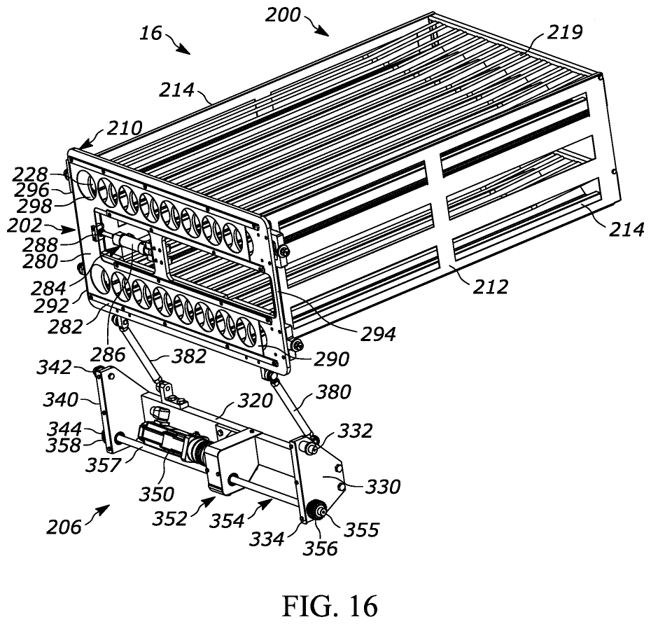

The cup loader assembly 16 is shown in FIGS. 12 through 16 as comprising a cup holding box 200, cup release assembly 202, guide assembly 204, and box movement subassembly 206. The cup holding box 200 includes base 210, first side wall 212, second side wall 212b, lower tray 214, lower guide rods 216, upper tray 218 and upper guide rods 219. The cup holding box is configured to receive and retain a plurality of cups for introduction into the magazine assembly. Thus, the configuration of the same, and the position of the stacks of cups and the bore at the base of the cup loader corresponds to the cup bores of the upper plate 54.

Base 210 is defined by top 220, bottom 222, first side 224, second side 226. The configuration of base 210 substantially matches the upper plate 54 of the magazine assembly. Additionally, base 210 has a plurality of bores, sixteen in the configuration shown, which correspond to the cup bores of the upper plate of the magazine. The first side 224 and the second side 226 extend to the first side 20 and second side 22 of the frame 12, respectively.

The first side wall 212 includes proximal end 230, distal end 232, lower end 234 and upper end 236. The proximal end 230 extends from the top 222 of base 210 at the first side 224 thereof. The distal end is opposite the proximal end 230. The upper end and the lower end refer to the oblique orientation when the cup holding box is in a cup loading configuration, whereas in the magazine loading configuration, the first side wall is substantially vertical. The second side wall 212b is opposite the first side wall 212, and extends from top 222 of base 210 at the second side 226 thereof. The lower tray and guide rods (with the cross beam) define lower receiving opening 246, wherein the rows of cups can be inserted into the cup holding box. The remaining configuration is a mirror image, preferably, of the first side wall, and as such any similar structures are identified with the same reference number augmented with a “b”.

The lower tray 214 is shown as including a proximal end 240, distal end 242 and upper surface 244. The upper surface 244 is configured with undulations to define channels that are configured to receive stacks of cups therealong between the proximal end and distal end thereof. Opposite the lower tray are the lower guide rods 216 which are configured to capture the stacks of cups positioned on the upper surface 244 (when in the cup loading configuration), and provide guides to maintain the position of the rows of cups in the magazine loading configuration. The lower guide rods have a proximal end 250 and a distal end 252. A cross beam is positioned to join the guide rods at the distal end thereof.

The upper tray 218 and the upper guide rods 219 are substantially same as the lower tray 214 and the lower guide rods 216. The two function in a similar manner to hold, in the configuration shown, eight rows of cups in a side by side configuration. The upper tray 218 includes proximal end 260 and distal end 262, with upper surface 264. The upper guide rods 219 include proximal end 270, distal end 272. Cross beam 274 extends across the upper guide rods at the distal end thereof. The upper tray and guide rods (with the cross beam) define upper receiving opening 266, wherein the rows of cups can be inserted into the cup holding box.

It will be understood that different configurations are contemplated, such as configurations that utilize guide rods instead of trays, or configurations that utilize trays instead of guide rods. It is also contemplated that while a pair of receiving openings 246, 266 are formed, in other configurations, a greater number of separate receiving openings can be formed as different portions can be divided in different manners.

The cup release assembly 202 includes stopper tray 280, guide channels 282 and actuator 284. The stopper tray 280 is defined by a top 290, bottom 292, a first side 294, a second side 296. A plurality of bores, such as bore 298, are defined in the stopper tray 280. The bores 298 correspond to the bores 228 of the base 210, and also the cup bores of the magazine. The stopper tray 280 abuts the bottom 222 of the base 210 in slidable engagement, with the guide channels 282 controlling the relative slidable movement of the components. That is, the stopper tray can slide along the channels formed by the guide channels which are coupled to the bottom of the base 210.

The cup release actuator 284 includes body 286 that is coupled to the base 210, and the actuator rod 288 is coupled to the stopper tray 280. In the configuration shown, the cup release actuator comprises a pneumatic cylinder, while other actuators are contemplated, including, but not limited to solenoids and other mechanical and/or electro-mechanical actuators. It will be understood, and as will be explained, that the actuator directs the stopper tray along the channels from a blocking configuration wherein there is not alignment of the bores 298 of the stopper tray with the bores 228 of the base 210 (where a portion of the stopper tray blocks the bore 228 of the base 210), to a release configuration wherein the bores 298 are placed into alignment with the bores 228 of the base 210 (which then allows for passage of cups through the bores of the base 210 and the stopper tray 280.

Guide assembly 204 comprises a first side mating track 300 and second side mating track 310 opposite the first side mating track. The first side mating track extends along the inside surface of the first front leg 40 and the first upper support 38 (and in a continuous manner across curved portion 44) between a first end 302 and a second end 304. The second side mating track 310 is a substantial mirror image of the first side mating track and extends along the inside surface of the second front leg 40b and the second upper support 38b (in a continuous manner across curved portion 44b) between a first end 312 and a second end 314. In the configuration shown, the first side and second side mating tracks comprise a continuous (or substantially continuous) slot that is substantially uniform therealong (while variations are contemplated (i.e., detents and the like)).

Additionally, guide assembly 204 further includes first side mating pins 306, 308 which extend outwardly from first side 224 of base 210, and, second side mating pins 316, 318. The first side mating pins 306, 308 are configured to slidably move within the first side mating track 300. The second side mating pins 316, 318 are configured to slidably move within the second side mating track 310.

The box movement assembly 206 is shown in FIGS. 12 through 17 as comprising lower slide 320, first side bracket 330, second side bracket 340, motor 350, first side rack 360 and second side rack 370. The box movement assembly 206 is attached to the base 210 of the cup holding box 200 through linkages 380, 382 which are pivotably coupled to each of the lower slide 320 of the box movement assembly and to base 210 of the cup holding box 200.

The lower slide 320 includes first side 322, second side 32, top surface 326 and bottom surface 328. The lower slide extends between first side 20 and second side 22 of the frame 12. The first side bracket 330 is coupled to the first side 322 of the lower slide 320 and includes first guide pin 332 and second guide pin 334 which extend outwardly from the first side bracket in a spaced apart orientation, configured to be slidably positioned within the first side mating track 300.

Similarly, the second side bracket 340 is positioned on the second side 324 of the lower side 320, and includes first guide pin 342 and second guide pin 344 which extend outwardly from the second side bracket in a spaced apart orientation, configured to be slidably positioned within the second side mating track 310.

The motor 350 is positioned on the bottom surface 328 of the lower slide 320 and is coupled to a transmission 352. Output axle 354 extends from the transmission in opposite directions with a first end 355 including gear 356, and a second end 357 including gear 358. The axle is coaxial with the second guide pins 334, 344, such that the gears extend about a portion of the guide pin that extends from the opposing first and second side brackets 330, 340.

A first side rack 360 is mounted to the first front leg 40 in an orientation wherein the first gear 356 meshes with the first side rack 360. The first side rack includes a lower end 362 and an upper end 364. The second side rack 370 is mounted to the second front leg 40b in an orientation wherein the second gear 358 meshes with the second side rack 370. The second side rack includes a lower end 372 and an upper end 374. Advantageously, with the use of the linkages 380, 382, the first and second side racks can be substantially linear, and while the cup holding box pivots from an oblique configuration to a vertical configuration, the racks are not required to have an arcuate configuration (while other configurations are contemplated).

The operation will be described with respect to the process of loading the cup loader assembly with cups, then loading the magazine assembly with cups from the cup loader assembly, and dispensing cups from the magazine assembly (for eventual filling by a filler). It will be understood that, in some configurations, the cup loader assembly of the present disclosure can be mated to a different type of cup magazine assembly (or a cup feeding assembly), and that the cup magazine assembly can be utilized without the cup loader assembly or with may be loaded in a manner different than through the use of the cup loader assembly. Additionally, it will be understood that it is contemplated that many different steps or things may occur once a cap is removed from the cup magazine assembly, such as, filling among other processes which may or may not be related to filling.

In particular, a supply of desired cups to be filled are first provided. As set forth above, it is contemplated that the system can handle many different types of cups having many different dimensions and the like. It is contemplated that components can be changed out so that differently sized and shaped cups can be utilized with the same filler.

Once supplied, and starting with the magazine being empty, the cup loader assembly is moved into the magazine loading configuration wherein the cup holding box is moved to the bottom end 32 of the front legs 40, 40b. In such a configuration, the cup holding box is oriented at an angle that is oblique to the magazine frame 50. In such a configuration, the upper receiving opening 246 and the lower receiving opening 266 are both easily accessible by a user for filling the cup holding box with cups. Additionally, the upper tray 218 and the lower tray 214 are oriented in such a manner that the cups can be easily placed upon the upper surfaces thereof, and directed toward the proximal end and the base 210 of the cup holding box. It will be understood that the angle of the upper and lower trays (and, indeed the cup holding box) is generally perpendicular to the front legs 40, 40b, such that the upper and lower trays are angled at between 5° and 80° relative to the horizontal, and more preferably between 7° and 45°, and more preferably between 10° and 30°, while variations are contemplated. Such angular positioning allows for the ease of insertion and placement without having the cups proceed took quickly to the proximal end, or to tumble within the cup loader assembly. It will be understood that the stopper tray 280 is oriented such that the bores of the base 210 are blocked, and so that cups are precluded from being directed through the base and out of the cup loader assembly 16.

It is contemplated that the entirety of the cup holding box may be filled with cups, while it is contemplated that partial filling (either some of the channels formed in the tray being filled or all of the trays partially filled, or some combination of the same).

Once the cup holding box is filled as desired, the motor 350 can be actuated so as to translate the lower slide 320 and, through the linkages 380, 382, the cup holding box toward the top end of the front legs 40, 40b. In particular, the motor, through the transmission, rotates the axle and the opposing gears 356, 358 which then meshes with the first side rack 360 and the second side rack 370, respectively. Continued operation of the motor directs the lower slide 320 toward the top end 30 of the frame 12.

As the cup holding box is moving, the first side mating pins 306, 308 move along the first side mating track 300 and the second side mating pins 316, 318 move along the second side mating track 310. Eventually, the first side mating pin 306 and second side mating pin 316 reach the curved portion that translates the first and second mating tracks to the upper supports of the frame. At such time, continued movement will alter the orientation of the cup holding box toward a vertical orientation. Eventually, all of the mating pins 306, 308, 316, 318 are positioned within respective mating tracks that align with the upper supports. In the configuration shown, the rack remains linear, such that the movement of the lower slide is fully linear from the lower end to the upper end of first and second side racks 360, 370. Advantageously, the cups remain linear throughout the transition, and, the cups are, preferably, not moved through an arcuate path as they are fed (i.e., the guide rods and the path of the cups remains linear, even with translation of the entirety of the box, thereby minimizing the tumbling of the cups).

Eventually, as the second end is approached, at some point, the bores 228 of the cup holding box 200 align with the cup bores 76 of the upper plate 54 of the cup magazine assembly 14. Once aligned, the cups can be fed from the cup loader assembly 16 to the cup magazine assembly 14 when needed and/or desired.

Prior to the directing of the cups into the cup magazine assembly 14, it may be desirable to prepare the cup magazine assembly for accepting cups. For example, the holdback assemblies can be configured to preclude or to allow passage of cups therebeyond. Additionally, the cup dropper assembly can be configured to preclude the passage of cups therebeyond.

Once the cup magazine is configured as desired (or in other instances, such configuration may occur as the transfer of cups is directed from the cup loading assembly to the cup magazine assembly), the cup release assembly can be activated so as to allow cups to pass through the bores 288 of the base of the cup holding box 200 and out of the cup holding box 200.

In particular, the actuator 284 is actuated so as to align the bores 298 with the bores 228 so that passage of cups is permitted. Once permitted, the cups will slide from the cup holding box (along the corrugations of the upper tray 218 and lower tray 214 and guided by the upper and lower guide rods 218, 219) and through the corresponding one of the cup bores 76 of the upper plate 54 of the cup magazine assembly 14.

In the configuration shown, it is contemplated that the cup retainer assemblies can be selectively actuated to preclude and/or allow the cups to pass through the respective bores of the first holdback assembly, and similarly through the bores of the second holdback assembly. It will be understood that different types of filling procedures are contemplated. For example, the cups can be stopped at each of the holdback assemblies so as to control the passage of cups therethrough. In other instances, the cups can be allowed to pass through the entirety of the magazine to the lower plate 52. Finally, it may be able to control the passage through the bores of the base of the cup holding assembly.

It will be understood that to selectively allow or preclude the passage beyond a holdback plate, the respective inner actuators and outer actuators, such as the combination of inner actuator 122 and outer actuator 126, can move the respective inner retaining bracket 120, and outer retaining bracket 124 so as to selectively block or allow for the passage of cups therethrough. It is contemplated that the loading can occur in stages, such that, for example, each holdback assembly retains a desired amount of cups, and, for example, the holdback assemblies can be controlled (i.e., the cup retainer sub-assemblies of the holdback assemblies) so that there are three stacks (in the example shown) of cups, a stack above the lower plate 52, a stack above the first holdback assembly and a stack above the second holdback assembly. They can, for example, be sequentially released. Of course, variations are contemplated. Notably, from the cup loading, to the cup magazine and to the release, the cup travels linearly, so as to improve the nested configuration, and to minimize the possibility of separation and tumbling of cups within any stream.

It will be understood that the cup loading box may be maintained in the magazine loading configuration as long as desired. Once it is desired to refill or to reorientate the cup loading box, the procedure with respect to the movement of the cup loading box can be reversed and the cup loading box can return to the cup loading configuration. It will be understood that the cup loading box can be stopped between the cup loading configuration and the magazine loading configuration as desired. Additionally, the movement of the cup loading box can be done regardless of the operation of the cup magazine assembly 14.

Returning to the operation of the cup magazine assembly to dispense cups downstream (i.e., to a filler or other device), once the cups reach the lower plate 50 of the magazine frame, the lowermost cups extend through the respective cup bore and are retained in place by cup dropper assembly. More specifically, initially, the lower lobes 183 extend into the footprint of the cup bores 66 of the lower plate, and engage the lip or rim of each of the respective ones of the cups.

To dispense a series of cups (i.e., a cup from each one of the cup bores 66 of the lower plate), the actuator 178 moves the push rods (such as push rod 176). As the push rods 176 move linearly, through the engagement with the drive pivots 188 of the cup dropper disks 172, such movement causes each of the cup dropper disks to rotate about the pivot shaft 174. As the cup dropper disks rotate, the lower lobes 183 move out of the footprint of the respective cup bores 66 of the lower plate 52, which allows the lowermost cup in each of the cup bores to exit the magazine frame. At the same time that the lower lobes 183 are moving out of the footprint of the respective cup bores, the upper lobes 181 enter into the footprint of the cup bores. Such entry directs the upper lobes between the lowermost cup and the immediately following cup. The upper lobes preclude further cups from passing through and out of the cup magazine frame. Due to the channel 184 therebetween, as well as the configuration of the upper and lower lobes, the lower cup may be urged to separate and drop out of the magazine frame.

Once the cups have dropped, and the upper lobes 181 are within the footprint of the respective cup bores of the lower plate, the cup dropper disks can be rotated to the initial position. In greater detail, the actuator 178 is actuated in the reverse direction, wherein the upper lobes begin to exit the footprint of the cup bores of the lower plate, while the lower lobes enter the footprint of the cup bores. Eventually, the upper lobes lose contact with the lowermost cup (as the upper lobes exit the footprint), and the cups fall. By this time, the lower lobes 183 are in the footprint of the cup bores, and capture the lowermost cup, preclude exit thereof from the magazine frame.

The process is repeated over and over to dispense successive ones of the cups. The process can be continuous, wherein the cup holding box is repeatedly filled, and repeatedly, the cups in the cup holding box are transferred to the cup magazine assembly, wherein the cups can be managed by the hold back assemblies, and eventually dispensed through the cup dropper assembly.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A cup handling apparatus comprising:
frame;
a cup magazine assembly attached to the frame, the cup magazine assembly including:
a magazine frame with a lower plate and an upper plate spaced apart from the lower plate, the upper plate having a plurality of cup bores, and the lower plate having a plurality of cup bores, with guides extending between the upper and lower plate about the cup bores of the upper and lower plates; and
a cup dropper assembly comprising a plurality of cup dropper disks that are rotatably extendable into the footprint of the cup bores of the lower plate, each cup dropper disk having an upper portion having at least one upper lobe and a lower portion having at least one lower lobe, defining a channel therein; and
a cup loader assembly attached to the frame including:
a cup holding box structurally configured to receive cups, and including a base having a plurality of bores that correspond to the cup bores of the upper plate;
a cup release assembly slidably movable relative to the base of the cup holding box, to selectively correspond to the plurality of bores of the base;
a box movement subassembly which guides the cup holding box from a cup loading configuration wherein the cup holding box is oblique to the cup magazine frame to a magazine loading configuration wherein the cup holding box overlies the magazine frame with the plurality of bores of the base aligned with the cup bores of the upper plate.

2. The cup handling apparatus of claim 1 wherein the magazine frame further includes at least one holdback assembly positioned between the upper plate and the lower plate, the at least one holdback assembly including a cup retainer subassembly selectively precluding and allowing the passage of cups therebeyond.

3. The cup handling apparatus of claim 2 wherein the at least one holdback assembly further includes a holdback plate that is positioned so as to be substantially parallel to at least one of the lower plate and the upper plate, and further including an inner retaining bracket positioned on an inner side of at least one of the cup bores and an outer retaining bracket positioned on an outer side of the at least one of the cup bores, the inner retaining bracket and the outer retaining bracket extendable into the at least one of the cup bores to selectively preclude and allow the passage of a cup therebeyond.

4. The cup handling apparatus of claim 3 wherein each of the outer retaining bracket and the inner retaining bracket further include a cup capture flange and an outer surface which cooperate to retain a cup and preclude the passage of the cup therebeyond.

5. The cup handling apparatus of claim 1 wherein the upper portion of the cup dropper disk includes four upper lobes and four lower lobes, with at least one of the cup dropper disks having at least one of the four upper lobes and at least one of the four lower lobes extendable into two adjacent cup bores of the lower plate of the magazine frame simultaneously.

6. The cup handling apparatus of claim 1 wherein the cup dropper disk further includes a drive pivot that is spaced apart from the pivot axis, cup dropper assembly further includes a push rod being slidably movable relative to the pivot axis while being coupled to the drive pivot, wherein slidable movement of the push rod engages the drive pivot, rotating the cup dropper disk.

7. The cup handling apparatus of claim 6 wherein the push rod engages a drive pivot of a plurality of cup dropper disks, whereupon slidable movement of the push rod rotates a plurality of the cup dropper disks.

8. The cup handling apparatus of claim 7 wherein the push rod is attached to an actuator that is coupled to the magazine frame, the actuator configured to slidably move the push rod.

9. The cup handling apparatus of claim 1 further comprising a guide assembly including:
a first side mating track extending along a portion of a first side the frame;
a second side mating track extending along a portion of a second side of the frame;
a pair of first side mating pins being spaced apart and extending from a first side of the base and extendable into the first side mating track, the first side mating pins being movable along the first side mating track;
a pair of second side mating pins being spaced apart and extending from a second side of the base and extendable into the second side mating track, the second side mating pins being movable along the second side mating track.

10. The cup handling apparatus of claim 9 wherein:
the first side of the frame includes a front leg and an upper support with a curved portion therebetween;
the second side of the frame includes a front leg and an upper support with a curved portion therebetween;
and wherein:
the first side mating track extending along a portion of the front leg, upper support and curved portion of the first side of the frame; and
the second side mating track extending along a portion of the front leg, upper support and curved portion of the second side of the frame.

11. The cup handling apparatus of claim 9 wherein the front leg is oblique to the upper support of the first side of the frame, while being substantially parallel to the upper plate of the magazine frame; and wherein the front leg is oblique to the upper support of the second side of the frame, while being substantially parallel to the upper plate of the magazine frame.

12. The cup handling apparatus of claim 9 wherein the box movement assembly further includes:
a lower slide including a first guide pin slidably positionable within the first side mating track and a second guide pin slidably positionable within the second side mating track;
a motor coupled to the lower slide and including an axle terminating in a gear; and
at least one side rack associated with at least one of the front leg of the first side of the frame and the front leg of the second side of the frame, the gear meshable with the at least one side rack, whereupon actuation of the motor rotates the gear and translates the lower slide relative to the at least one side rack; and
at least one linkage coupling the lower slide to the cup holding box, wherein the cup holding box is structurally configured to rotate relative to the lower slide.

13. The cup handling apparatus of claim 12 wherein the axle includes a second gear, and the at least one rack comprises a first rack associated with the front leg of the first side of the frame and a second rack associated with the front leg of the second side of the frame, with the gear meshing with the first rack and the second gear meshing with the second rack.

14. The cup handling apparatus of claim 1 wherein a travel of a cup through the cup magazine and through the cup loader assembly is linear.

15. A cup loader assembly attachable to a frame, the cup loader assembly comprising:
a cup holding box structurally configured to receive cups, and including a base having a plurality of bores that correspond to the cup bores of the upper plate;
a cup release assembly slidably movable relative to the base of the cup holding box, to selectively correspond to the plurality of bores of the base;
a box movement subassembly which guides the cup holding box from a cup loading configuration wherein the cup holding box is oblique to a cup magazine frame to a magazine loading configuration wherein the cup holding box overlies the magazine frame with the plurality of bores of the base aligned with the cup bores of the upper plate.

16. The cup handling apparatus of claim 15 further comprising a guide assembly including:
a first side mating track extending along a portion of a first side the frame;
a second side mating track extending along a portion of a second side of the frame;
a pair of first side mating pins being spaced apart and extending from a first side of the base and extendable into the first side mating track, the first side mating pins being movable along the first side mating track;
a pair of second side mating pins being spaced apart and extending from a second side of the base and extendable into the second side mating track, the second side mating pins being movable along the second side mating track.

17. The cup handling apparatus of claim 16 wherein:
the first side of the frame includes a front leg and an upper support with a curved portion therebetween;
the second side of the frame includes a front leg and an upper support with a curved portion therebetween;
and wherein:
the first side mating track extending along a portion of the front leg, upper support and curved portion of the first side of the frame; and
the second side mating track extending along a portion of the front leg, upper support and curved portion of the second side of the frame.

18. The cup handling apparatus of claim 9 wherein the box movement assembly further includes:
a lower slide including a first guide pin slidably positionable within the first side mating track and a second guide pin slidably positionable within the second side mating track;
a motor coupled to the lower slide and including an axle terminating in a gear; and
at least one side rack associated with at least one of the front leg of the first side of the frame and the front leg of the second side of the frame, the gear meshes with the at least one side rack, whereupon actuation of the motor rotates the gear and translates the lower slide relative to the at least one side rack; and
at least one linkage coupling the lower slide to the cup holding box, wherein the cup holding box is structurally configured to rotate relative to the lower slide.

19. A cup magazine assembly attachable to the frame, the cup magazine assembly including:
a magazine frame with a lower plate and an upper plate spaced apart from the lower plate, the upper plate having a plurality of cup bores, and the lower plate having a plurality of cup bores, with guides extending between the upper and lower plate about the cup bores of the upper and lower plates; and
a cup dropper assembly comprising a plurality of cup dropper disks that are rotatably extendable into the footprint of the cup bores of the lower plate, each cup dropper disk having an upper portion having at least one upper lobe and a lower portion having at least one lower lobe, defining a channel therein.

20. The cup handling apparatus of claim 19 wherein the upper portion of the cup dropper disk includes four upper lobes and four lower lobes, with at least one of the cup dropper disks having at least one of the four upper lobes and at least one of the four lower lobes extendable into two adjacent cup bores of the lower plate of the magazine frame simultaneously.
